(19) United States
(12) Patent Application Publication
(10) Pub. No.: US 2017/0185964 A1
(43) Pub. Date: Jun. 29, 2017

(54) METHODS AND SYSTEMS FOR MATCHING CANDIDATES AND JOB POSITIONS BI-DIRECTIONALLY USING COGNITIVE COMPUTING

(71) Applicant: International Business Machines Corporation, Armonk, NY (US)

(72) Inventors: Gabriel Pereira Borges, Sao Paulo (BR); Alan Braz, Sao Paulo (BR); Paulo Henrique De Almeida Cavoto, Sao Paulo (BR); Paulo Marques Caldeira, JR., Sao Paulo (BR); Argemiro De Lima, Sao Paulo (BR)

(21) Appl. No.: 14/979,945

(22) Filed: Dec. 28, 2015

(51) Int. Cl. G06Q 10/10; G06N 5/02

(52) U.S. Cl. CPC G06Q 10/1053; G06N 5/02

(57) ABSTRACT

Embodiments include methods, and computer program products for matching candidates and job positions using cognitive computing. Aspects include: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

### BACKGROUND

The present disclosure relates generally to information technology, and more particularly to methods, systems and computer program products for matching candidates and job openings using cognitive computing.

Every day millions of job seekers, employers and headhunters work to make matches in all types of vocational spaces. Despite solid advancements in the connectedness of structured databases and websites, the matching process remains inefficient and inadequate. Finding a best candidate for a given job position, or finding a best fit job for a given candidate is a knowledge intensive task, and there are many variables involved in the decision-making process rather than just candidate's skills. When a candidate is selected for a position solely based on his/her skills, the social behaviors are not properly addressed, and this can lead to dissatisfaction for both hiring company and employee. Behavior representation of a candidate may be just as important as the candidate's skills and experiences.

When working on a system where data come from both as structured and unstructured formats, it is important to neutralize differences in between the same data document and represent the data in a uniform format such that fair comparisons can be made. It is desirable to have a cognitive system that uses various cognitive methods to build enhanced job openings and candidate resumes knowledge bases that will support candidates and Human Resources (HR) analysts to find the best match between available candidates and the job openings.

Therefore, heretofore unaddressed needs still exist in the art to address the aforementioned deficiencies and inadequacies.

### SUMMARY

In an embodiment of the present invention, a method of matching candidates and job openings using cognitive computing may include: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings by ranking the extracted cognitive features and cognitive computing. The extracted cognitive features may include a list of personality traits and a list of concepts.

In another embodiment of the present invention, a computer system for matching candidates and job openings using cognitive computing may include a processor, and a memory storing computer executable instructions for the computer system. When the computer executable instructions are executed at the processor, the computer executable instructions cause the computer system to perform: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

In yet another embodiment of the present invention, a non-transitory computer storage medium may store computer executable instructions. When these computer executable instructions are executed by a processor of a computer system, these computer executable instructions cause the computer system to perform: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating an exemplary computer system for matching candidates and job openings using cognitive computing according to certain embodiments of the present invention; and

FIG. 2 is a flow chart of an exemplary method of matching candidates and job openings using cognitive computing according to certain embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “plurality” means two or more. The terms “comprising,” “including,” “carrying,” “having,” “containing,” “involving,” and the like are to be understood to be open-ended, i.e., to mean including but not limited to.

The term computer program, as used above, may include software, firmware, and/or microcode, and may refer to programs, routines, functions, classes, and/or objects. The term shared, as used above, means that some or all code from multiple modules may be executed using a single (shared) processor.

“NLP” stands for neuro-linguistic programming. NLP is an approach to communication, personal development, psychotherapy.

“The Big 5” are five broad factors (dimensions) of personality traits. They are: (1) Extraversion: includes traits like talkative, energetic, and assertive, (2) Agreeableness: includes traits like sympathetic, kind, and affectionate, (3) Conscientiousness: includes traits like organized, thorough, and planful, (4) Neuroticism: includes traits like tense, moody, and anxious, and (5) Openness to Experience: includes traits like having wide interests, and being imaginative and insightful.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

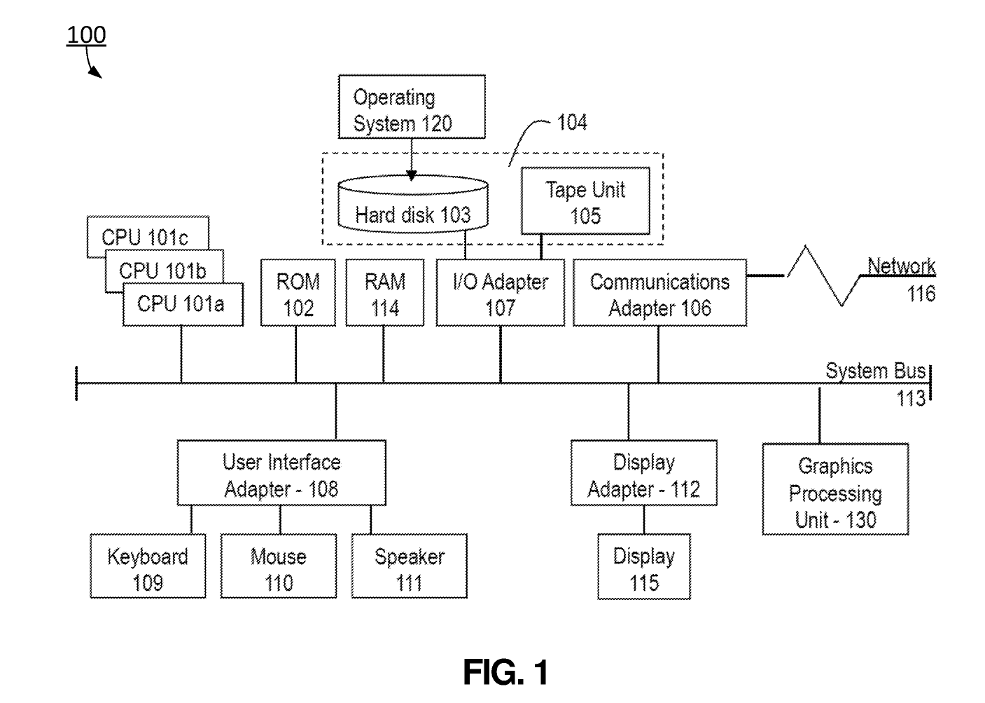

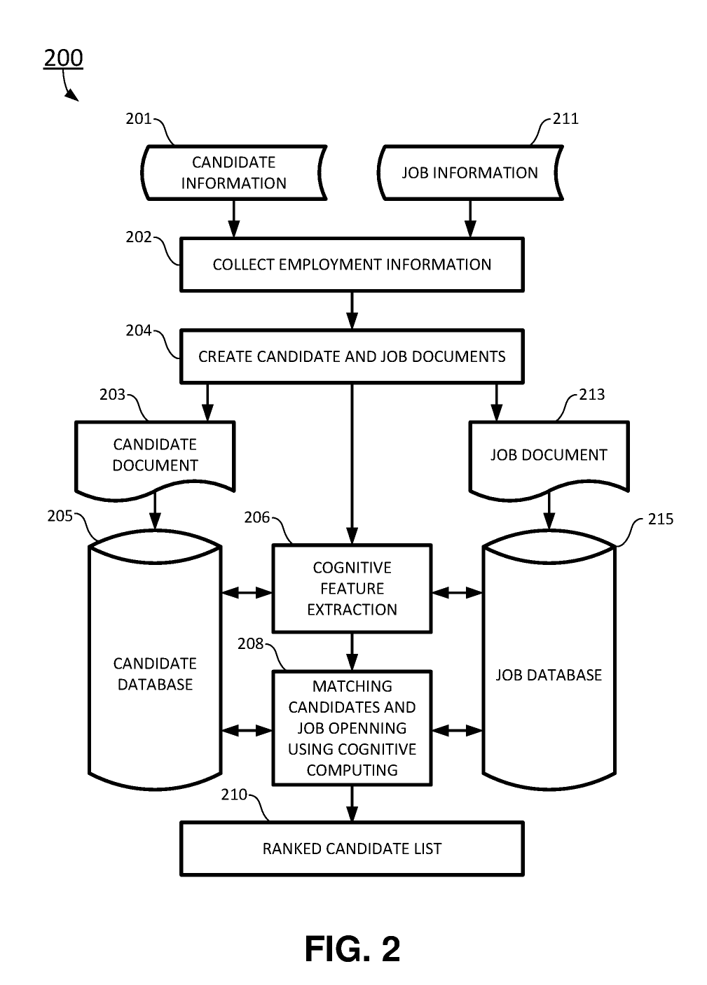

The present disclosure will now be described more fully hereinafter with reference to the accompanying drawings FIGS. 1-2, in which certain exemplary embodiments of the present disclosure are shown. The present disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Referring to FIG. 1, there is shown an embodiment of a computer system 100 for matching candidates and job openings using cognitive computing and implementing the teachings herein. In this embodiment, the computer system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of the computer system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the computer system 100 may be stored in mass storage 104. A network adapter 106 interconnects bus 113 with an outside network 116 enabling the computer system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the computer system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the computer system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1. In certain embodiments, the network 116 may include symmetric multiprocessing (SMP) bus, a Peripheral Component Interconnect (PCI) bus, local area network (LAN), wide area network (WAN), telecommunication network, wireless communication network, and the Internet.

In certain embodiments, the hard disk 103 stores software for the computer system 100 for matching candidates and job openings using cognitive computing. In certain embodiments, when the software is executed at the processor 101, the computer system 100 may perform: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

In certain embodiments, the creating operation may include: creating a candidate document and creating a job document. The creating the candidate document may include: parsing information of a candidate into a candidate text file, removing all line breaks from the candidate text file, creating the corresponding candidate document with personal identification for the candidate, and storing the candidate document created in the candidate database. The creating a job document may include: parsing information of a job opening into a job text file, removing all line breaks from the job text file, creating a corresponding job document with job identification for the job opening, and storing the job document created in the job database.

In exemplary embodiments, the extracting operation may include: extracting personality traits from a document using a first cognitive algorithm, and extracting concepts from the document using a second cognitive algorithm. The document here may include one of the candidate documents in the candidate database, and one of the job documents in the job database.

In certain embodiments, the operation of extracting personality traits from a document using the first cognitive algorithm may include: analyzing each word from the text file of the document using neuro-linguistic programming (NLP), extracting certain personality traits using one or more psychology models, and storing the personality traits extracted in the list of personality traits of the corresponding document. The document here may include one of the candidate documents in the candidate database; and one the job documents in the job database. The text file here may include: the candidate text file of the corresponding candidate document, and the job text file of the corresponding job document.

In certain embodiments, the operation of extracting concepts from the document using the second cognitive algorithm may include: understanding each word from the text file of the document using neuro-linguistic programming (NLP), searching in certain knowledge sources to retrieve meta-information of the word, extracting certain concepts from the retrieved meta-information, and storing the certain concepts extracted in the list of concepts of the corresponding document. The document here may include one of the candidate documents in the candidate database; and one the job documents in the job database. The text file here may include: the candidate text file of the corresponding candidate document, and the job text file of the corresponding job document.

In certain embodiments, the matching may include: comparing each personality trait from the list of personality traits of each of the candidate documents in the candidate database with each personality trait from the list of personality traits of each of the job documents in the job database with a first predetermined criterion and obtain a personality score for each of the candidates, comparing each concept from the list of concepts of each of the candidate documents in the candidate database with each concept from the list of concepts of each of the job documents in the job database with a second predetermined criterion and obtain a concept score for each of the candidates, ranking the personality scores and the concept scores for each of the candidates, and generating a list of candidates of recommendation based on a combined personality and concept ranking. Each of the first predetermined criterion and the second predetermined criterion may include: a criterion based on similarity level, a criterion based on scale level, a criterion based on effectiveness level, and a criterion based on confidence level.

Referring now to FIG. 2, a flow chart of an exemplary method 200 of the computer system 100 for matching candidates and job openings is shown according to certain exemplary embodiments of the present disclosure. As shown at block 202, the computer system 100 may collect candidate information from a number of candidate information sources as shown as external documents 201. For example, the candidate information sources 201 may include: employers' databases of job applications, headhunter's databases, internal referral databases, and websites where employers collect applications for jobs. These are candidate information related to candidate's skills and experiences. In addition to candidate information collected from the applications from various sources, databases and websites, the computer system 100 may also collect candidates' behaviors through a variety of social media outlets such as Facebook, Twitter, LinkedIn, Pinterest, Google+, Tumblr, Instagram, Vine, Meetup, and Classmates etc.

On the other hand, the computer system 100 may collect job opening information from many different job information sources as shown as external documents 211. For example, the job information sources 211 may include: a job databank, employment websites such as monster.com, indeed.com, and careerbuilder.com, headhunters' websites, government job websites such as usajobs.gov, and nationjob.com, or department of labor of the United States, or department of labor of various states, etc.

At block 204, the computer system 100 may create one candidate document 203 for each of the candidates collected, and one job document 213 for each of the job openings collected. In certain embodiment, the operation of creating candidate document may include: parsing information of a candidate into a candidate text file, removing all line breaks from the candidate text file, creating the corresponding candidate document with personal identification for the candidate, and storing the candidate document created in the candidate database 205. The operation of creating job document may include: parsing information of a job opening into a job text file, removing all line breaks from the job text file, creating a corresponding job document with job identification for the job opening, and storing the job document created in the job database 215.

At block 206, the computer system 100 may access the candidate documents 203 in the candidate database 205, and the job documents 213 in the job database 215 to extract cognitive features from the candidate documents 203 and the job documents 213. In certain embodiments, the cognitive features may include a set of personality traits and a set of concepts. The cognitive features extractions may include extracting personality traits from each of the candidate documents 203 in the candidate database 205 and the job documents 213 in the job database 215 using a first cognitive algorithm, and extracting concepts from each of the candidate documents 203 in the candidate database 205 and the job documents 213 in the job database 215 using a second cognitive algorithm.

In certain embodiments, the extracting cognitive features using the first cognitive algorithm may include: analyzing each word from the text file of the document using neuro-linguistic programming (NLP), extracting certain personality traits using one or more psychology models, and storing the personality traits extracted in the list of personality traits of the corresponding document. The document here may include one of the candidate documents 203 in the candidate database 205 and one the job documents 213 in the job database 215. The text file here may include: the candidate text file of the corresponding candidate document 203 and the job text file of the corresponding job document 213. An example of the psychology models is “The Big 5” model. “The Big 5” model, also known as five factor model (FFM), is widely examined theory of five broad dimensions used by some psychologists to describe the human personality and psyche. The five factors have been defined as openness to experience, conscientiousness, extraversion, agreeableness, and neuroticism.

In certain embodiments, the extracting cognitive features using the second cognitive algorithm may include: understanding each word from the text file of the document using neuro-linguistic programming (NLP), searching in certain knowledge sources to retrieve meta-information of the word, extracting certain concepts from the retrieved meta-information, and storing the certain concepts extracted in the list of concepts of the corresponding document. The document here may include one of the candidate documents 203 in the candidate database 205 and one the job documents 213 in the job database 215. The text file here may include: the candidate text file of the corresponding candidate document 203 and the job text file of the corresponding job document 213. An example of the knowledge sources may be a knowledge graph (KG), a knowledge base used by Google to enhance its search engine's search results with semantic-search information gathered from a wide variety of sources. It provides structured and detailed information about the topic in addition to a list of links to other sites. The goal is that users would be able to use this information to resolve their query without having to navigate to other sites and assemble the information themselves.

In certain embodiments, once the cognitive features are extracted for each of the documents 203 and 213, each of the list of personality traits and the list of concepts of these documents is updated with its corresponding cognitive features extracted.

At block 208, the computer system 100 may match the candidates and the job openings bi-directionally using cognitive computing. In certain embodiments, the matching may include: comparing each personality trait from the list of personality traits of each of the candidate documents in the candidate database with each personality trait from the list of personality traits of each of the job documents in the job database with a first predetermined criterion and obtain a personality score for each of the candidates, comparing each concept from the list of concepts of each of the candidate documents in the candidate database with each concept from the list of concepts of each of the job documents in the job database with a second predetermined criterion and obtain a concept score for each of the candidates, ranking the personality scores and the concept scores for each of the candidates, and generating a list 210 of candidates of recommendation based on a combined personality and concept ranking. Each of the first predetermined criterion and the second predetermined criterion may include: a criterion based on similarity level, a criterion based on scale level, a criterion based on effectiveness level, and a criterion based on confidence level.

In certain embodiments, a third cognitive algorithm may be used to match the candidates and job openings. For example, the computer system 100 may pick a cognitive component such as a candidate document 203 from the candidate database 205, or a job document 213 from the job database 215, where the candidate document 203 and job document 213 follow the same document model, and each of the candidate document 203 and job document 213 may include a list of personality traits and a list of concepts. The computer system 100 may search a given data source containing n number of documents following this same document model, comparing it by their concepts and personality traits, ranking them according to preferences such as similarity, confidence and other criteria. Then, the computer system 100 will generate and return a list of n, given by input or preferences, documents found this way.

For example, in one embodiment, the computer system 100 may pick a candidate document 203 from the candidate database 205 to find a match for a job represented by the corresponding job document 213 in the job database 215. The computer system 100 may search through each of the job documents 213 in the job database 215 using the third cognitive algorithm and compare each of the job documents by their list of concepts and list of personality traits. The computer system 100 may generate a list of ranked job documents, ranked according to preferences such as similarity and confidence.

In another embodiment, the computer system 100 may pick a job document 213 from the job database 215 to find a match for a candidate represented by the corresponding candidate document 203 in the candidate database 205. The computer system 100 may search through each of the candidate documents 203 in the candidate database 205 using the third cognitive algorithm and compare each of the candidate documents by their list of concepts and list of personality traits. The computer system 100 may generate a list of ranked candidate documents, ranked according to preferences such as similarity and confidence.

In another embodiment of the present invention, a computer system for matching candidates and job openings using cognitive computing may include a processor, and a memory storing computer executable instructions for the computer system. When the computer executable instructions are executed at the processor, the computer executable instructions cause the computer system to perform: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

In yet another embodiment of the present invention, a non-transitory computer storage medium may store computer executable instructions. When these computer executable instructions are executed by a processor of a computer system, these computer executable instructions cause the computer system to perform: collecting candidate information of certain candidates and job information of certain job openings from various information sources, creating one candidate document for each of the candidates and storing the candidate document created in a candidate database, and creating one job document for each of the job openings and storing the job document created in a job database, extracting certain cognitive features from each of candidate documents in the candidate database, and each of the job documents in the job database using cognitive computing; and matching the candidates in the candidate database with the job openings in the job database by ranking the extracted cognitive features and cognitive computing. The extracted cognitive features may include a list of personality traits and a list of concepts.

The present invention may be a computer system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of matching candidates and job openings using cognitive computing comprising:
collecting candidate information of a plurality of candidates and job information of a plurality of job openings from a plurality of information sources;
creating a plurality of candidate documents including one candidate document for each of the plurality of candidates, and a plurality of job documents including one job document for each of the plurality of job openings, wherein each of the plurality of candidate documents and the plurality of job documents comprises a list of personality traits and a list of concepts;
extracting a plurality of cognitive features from each of the plurality of candidate documents, and each of the plurality of job documents using cognitive computing; and
matching the plurality of candidates with the plurality of job openings using cognitive computing.

2. The method of claim 1, wherein the creating comprises:
creating a candidate document comprising:
parsing information of a candidate into a candidate text file;
removing all line breaks from the candidate text file;
creating a corresponding candidate document with personal identification for the candidate; and
storing the candidate document created in a candidate database; and
creating a job document comprising:
parsing information of a job opening into a job text file;
removing all line breaks from the job text file;
creating a corresponding job document with job identification for the job opening; and
storing the job document created in a job database.

3. The method of claim 2, wherein the extracting comprises:
extracting personality traits from a document using a first cognitive algorithm; and
extracting concepts from the document using a second cognitive algorithm,
wherein the document comprises: one of the candidate documents in the candidate database, and one of the job documents in the job database.

4. The method of claim 3, wherein the first cognitive algorithm comprises:
analyzing each word from the text file of the document using neuro-linguistic programming (NLP);
extracting a plurality of personality traits using one or more psychology models; and
storing the plurality of personality traits extracted in the list of personality traits of the corresponding document,
wherein the document comprises: one of the candidate documents in the candidate database; and one the job documents in the job database, and the text file comprises: the candidate text file of the corresponding candidate document, and the job text file of the corresponding job document.

5. The method of claim 3, wherein the second cognitive algorithm comprises:
understanding each word from the text file of the document using neuro-linguistic programming (NLP);
searching in a plurality of knowledge sources to retrieve meta-information of the word;
extracting a plurality of concepts from the retrieved meta-information; and
storing the plurality of concepts extracted in the list of concepts of the corresponding document,
wherein the document comprises: one of the candidate documents in the candidate database; and one the job documents in the job database, and the text file comprises: the candidate text file of the corresponding candidate document, and the job text file of the corresponding job document.

6. The method of claim 3, wherein the matching comprises:
comparing each personality trait from the list of personality traits of each of the candidate documents in the candidate database with each personality trait from the list of personality traits of each of the job documents in the job database with a first predetermined criterion and obtain a personality score for each of the plurality of candidates;
comparing each concept from the list of concepts of each of the candidate documents in the candidate database with each concept from the list of concepts of each of the job documents in the job database with a second predetermined criterion and obtain a concept score for each of the plurality of candidates;
ranking the personality scores and the concept scores for each of the plurality of candidates; and
generating a list of candidates of recommendation based on a combined personality and concept ranking.

7. The method of claim 6, wherein each of the first predetermined criterion and the second predetermined criterion comprises:
a criterion based on similarity level;
a criterion based on scale level;
a criterion based on effectiveness level; and
a criterion based on confidence level.

8. A computer system for matching candidates and job openings using cognitive computing comprising:
a processor and a memory storing computer executable instructions for the computer system which, when executed at the processor of the computer system, are configured to perform:
collecting candidate information of a plurality of candidates and job information of a plurality of job openings from a plurality of information sources;
creating a plurality of candidate documents including one candidate document for each of the plurality of candidates, and a plurality of job documents including one job document for each of the plurality of job openings, wherein each of the plurality of candidate documents and the plurality of job documents comprises a list of personality traits and a list of concepts;
extracting a plurality of cognitive features from each of the plurality of candidate documents, and each of the plurality of job documents using cognitive computing; and
matching the plurality of candidates with the plurality of job openings database using cognitive computing.

9. The computer system of claim 8, wherein the creating comprises:
creating a candidate document comprising:
parsing information of a candidate into a candidate text file;
removing all line breaks from the candidate text file;
creating a corresponding candidate document with personal identification for the candidate; and
storing the candidate document created in a candidate database; and
creating a job document comprising:
parsing information of a job opening into a job text file;
removing all line breaks from the job text file;
creating a corresponding job document with job identification for the job opening; and
storing the job document created in a job database.

10. The computer system of claim 9, wherein the extracting comprises:
extracting personality traits from a document using a first cognitive algorithm; and
extracting concepts from the document using a second cognitive algorithm,
wherein the document comprises: one of the candidate documents in the candidate database, and one of the job documents in the job database.

11. The computer system of claim 10, wherein the first cognitive algorithm comprises:
analyzing each word from the text file of the document using neuro-linguistic programming (NLP);
extracting a plurality of personality traits using one or more psychology models; and
storing the plurality of personality traits extracted in the list of personality traits of the corresponding document,
wherein the document comprises: one of the candidate documents in the candidate database; and one the job documents in the job database, and the text file comprises: the candidate text file of the corresponding candidate document, and the job text file of the corresponding job document.

12. The computer system of claim 10, wherein the second cognitive algorithm comprises:
understanding each word from the text file of the document using neuro-linguistic programming (NLP);
searching in a plurality of knowledge sources to retrieve meta-information of the word;
extracting a plurality of concepts from the retrieved meta-information; and
storing the plurality of concepts extracted in the list of concepts of the corresponding document,
wherein the document comprises: one of the candidate documents in the candidate database; and one the job documents in the job database, and the text file comprises: the candidate text file of the corresponding candidate document, and the job text file of the corresponding job document.

13. The computer system of claim 10, wherein the matching comprises:
comparing each personality trait from the list of personality traits of each of the candidate documents in the candidate database with each personality trait from the list of personality traits of each of the job documents in the job database with a first predetermined criterion and obtain a personality score for each of the plurality of candidates;
comparing each concept from the list of concepts of each of the candidate documents in the candidate database with each concept from the list of concepts of each of the job documents in the job database with a second predetermined criterion and obtain a concept score for each of the plurality of candidates;
ranking the personality scores and the concept scores for each of the plurality of candidates; and
generating a list of candidates of recommendation based on a combined personality and concept ranking.

14. The computer system of claim 13, wherein each of the first predetermined criterion and the second predetermined criterion comprises:
a criterion based on similarity level;
a criterion based on scale level;
a criterion based on effectiveness level; and
a criterion based on confidence level.

15. A non-transitory computer storage medium having computer executable instructions stored thereon which, when executed by a processor of a computer system for matching candidates and job openings, cause the processor to perform:
collecting candidate information of a plurality of candidates and job information of a plurality of job openings from a plurality of information sources;
creating a plurality of candidate documents including one candidate document for each of the plurality of candidates, and a plurality of job documents including one job document for each of the plurality of job openings, wherein each of the plurality of candidate documents and the plurality of job documents comprises a list of personality traits and a list of concepts;
extracting a plurality of cognitive features from each of the plurality of candidate documents, and each of the plurality of job documents using cognitive computing; and
matching the plurality of candidates with the plurality of job openings using cognitive computing.

16. The non-transitory computer storage medium of claim 15, wherein the creating comprises:
creating a candidate document comprising:
parsing information of a candidate into a candidate text file;
removing all line breaks from the candidate text file;
creating a corresponding candidate document with personal identification for the candidate; and
storing the candidate document created in a candidate database; and
creating a job document comprising:
parsing information of a job opening into a job text file;
removing all line breaks from the job text file;
creating a corresponding job document with job identification for the job opening; and
storing the job document created in a job database.

17. The non-transitory computer storage medium of claim 16, wherein the extracting comprises:
extracting personality traits from a document using a first cognitive algorithm; and
extracting concepts from the document using a second cognitive algorithm,
wherein the document comprises: one of the candidate documents in the candidate database, and one of the job documents in the job database.

18. The non-transitory computer storage medium of claim 17, wherein the first cognitive algorithm comprises:
analyzing each word from the text file of the document using neuro-linguistic programming (NLP);
extracting a plurality of personality traits using one or more psychology models; and
storing the plurality of personality traits extracted in the list of personality traits of the corresponding document,
wherein the document comprises: one of the candidate documents in the candidate database; and one the job documents in the job database, and the text file comprises: the candidate text file of the corresponding candidate document, and the job text file of the corresponding job document.

19. The non-transitory computer storage medium of claim 17, wherein the second cognitive algorithm comprises:
understanding each word from the text file of the document using neuro-linguistic programming (NLP);
searching in a plurality of knowledge sources to retrieve meta-information of the word;
extracting a plurality of concepts from the retrieved meta-information; and
storing the plurality of concepts extracted in the list of concepts of the corresponding document,
wherein the document comprises: one of the candidate documents in the candidate database; and one the job documents in the job database, and the text file comprises: the candidate text file of the corresponding candidate document, and the job text file of the corresponding job document.

20. The non-transitory computer storage medium of claim 17, wherein the matching comprises:
comparing each personality trait from the list of personality traits of each of the plurality of candidate documents in the candidate database with each personality trait from the list of personality traits of each of the plurality of job documents in the job database with a first predetermined criterion and obtain a personality score for each of the plurality of candidates;
comparing each concept from the list of concepts of each of the plurality of candidate documents in the candidate database with each concept from the list of concepts of each of the plurality of job documents in the job database with a second predetermined criterion and obtain a concept score for each of the plurality of candidates;
ranking the personality scores and the concept scores for each of the plurality of candidates; and
generating a list of candidates of recommendation based on a combined personality and concept ranking,
wherein each of the first predetermined criterion and the second predetermined criterion comprises:
a criterion based on similarity level;
a criterion based on scale level;
a criterion based on effectiveness level; and
a criterion based on confidence level.
